(19) United States
(12) Patent Application Publication
(10) Pub. No.: US 2025/0153346 A1
(43) Pub. Date: May 15, 2025

(54) LOW-CLEARANCE PIPE TRAVERSING ROBOT

(71) Applicant: ARIX TECHNOLOGIES, INC., Houston, TX (US)

(72) Inventors: Karl Petter Wehlin, Conroe, TX (US); Bryan R. Duerfeldt, Houston, TX (US); Jakob R. Salazar, Houston, TX (US); Gail Paulin Murray, Tomball, TX (US); Curtis Woods Belknap, Houston, TX (US); Josh Figuered, Houston, TX (US); Conner S. George, Houston, TX (US); Eric J. Udell, Cypress, TX (US)

(21) Appl. No.: 18/949,087

(22) Filed: Nov. 15, 2024

Related U.S. Application Data
(60) Provisional application No. 63/661,306, filed on Jun. 18, 2024.
(60) Provisional application No. 63/599,130, filed on Nov. 15, 2023.
(60) Provisional application No. 63/599,120, filed on Nov. 15, 2023.

(51) Int. Cl. B25J 9/08; B25J 5/00; B25J 11/00

(52) U.S. Cl. CPC B25J 9/08; B25J 5/007; B25J 11/005

(57) ABSTRACT

A robotic apparatus for traversing the outer surface of a pipe, having: (i) first and second modules each having a clamping member coupling two wheels and positioning those wheels on first and second circumferential one-third portions of the pipe, and (ii) a third module connecting the first and second modules and positioning another wheel on a third circumferential one-third portion of the pipe; wherein the wheels are configured to permit movement of the modular robotic apparatus in axial, circumferential, and helical directions along the pipe. Another robotic apparatus having first and second wheel assemblies coupled by a clamping member and positioned on opposing circumferential half of the pipe, each wheel assembly having a wheel, a drive assembly for rotating the wheel about a driving axis, and a steering assembly for adjusting the direction in which the wheel is steered.

### CROSS-REFERENCE TO RELATED APPLICATION(S)

This application claims the benefit of and priority to U.S. Provisional Application No. 63/599,120, filed Nov. 15, 2023, U.S. Provisional Application No. 63/599,130, filed Nov. 15, 2023, and U.S. Provisional Application No. 63/661,306, filed Jun. 18, 2024, each of which is hereby incorporated herein by reference in its entirety for all purposes.

### BACKGROUND

Many existing pipe crawling apparatuses are designed to either travel inside of pipes or are not equipped to travel around obstacles it may encounter on the outside of pipes. In view of limitations of current technologies, a need remains for pipe-crawling apparatus that are effective in driving on horizontal and vertical pipes and navigating around and/or over potential obstacles—e.g., obstacles that present a change in the effective diameter of the pipe, a change in the effective curvature of the pipe, and/or obstacles that protrude from the pipe in one or more radial directions. More particularly, pipe-crawling apparatus are needed that are effective in navigating around and/or over flanges, valves, tees, bends, supports and the like.

In addition, a need remains for pipe-crawling apparatus that are effective in traveling relative to pipes without magnets, vacuum, or acrodynamic forces. For example, many existing robots utilize magnets (shown) to remain attached to pipes. Reliance on magnets adds significant weight to the robot, which can increase power consumption since (i) stronger motors and more powerful batteries to move the robot along the pipe (both of which, in turn, add even more weight), and (ii) those robots utilizing electromagnets must use even more power to generate the additional magnetic force required to compensate for the added weight of the larger motors and batteries. Likewise, the added weight of the magnets themselves requires one to use an even larger magnet in order to generate enough magnetic force to keep the robot (including the weight of the magnet) secured to the pipe. Magnets also do not work well (or at all) on insulated pipes since the insulation creates a gap between the magnet and the metal pipe. Further, the added weight of magnets can make robots more difficult to transport and install on the pipes. Still further, the amount of magnetic force cannot be adjusted without swapping out one magnet for another, which can be time consuming and labor intensive when it comes to transporting additional magnets.

Additionally, a need remains for pipe-crawling apparatus and associated systems that are effective in performing desired functions relative to the pipe itself, e.g., corrosion detection, wall thickness measurements, or based on travel along the path but independent of the pipe itself, e.g., imaging and/or sensing of locations accessible through travel along a pipe.

Still further, a need remains for a pipe-crawling apparatus that needs very little clearance to traverse nearby obstacles adjacent to the pipe, such as other pipes, and to do so with sufficient torque and speed be effective across a range of operations on both horizontal and vertical pipes.

These and other needs are advantageously satisfied by the apparatus and systems disclosed herein.

### SUMMARY

The present disclosure is directed to a robotic apparatus for traversing an outer surface of a pipe. The robotic apparatus, in various embodiments, may include a first module having: a first wheel and a second wheel, and a first clamping member coupling the first and second wheels and configured to (i) position the first wheel on a first circumferential one-third portion of an outer surface of a pipe, (ii) position the second wheel on a second circumferential one-third portion of the outer surface of the pipe, and (iii) apply a force for urging the first and second wheels towards the outer surface of the pipe for securing the robotic apparatus to the pipe; a second module having: a third wheel and a fourth wheel, and a second clamping member coupling the third and fourth wheels and configured to (i) position the third wheel on the first circumferential one-third portion of the outer surface of the pipe, (ii) position the fourth wheel on a second circumferential one-third portion of the outer surface of the pipe, and (iii) apply a force for urging the third and fourth wheels towards the outer surface of the pipe for securing the robotic apparatus to the pipe; and a third module having: a fifth wheel, and a connecting member having a first end coupled to the first module and a second end coupled to the second module so as to (i) position the fifth wheel on a third circumferential one-third portion of the outer surface of the pipe, and (ii) position the first module and second module at different axial positions along a length of the pipe. The first, second, third, fourth, and fifth wheels may each be configured to permit movement of the modular robotic apparatus in axial, circumferential, and helical directions along the pipe.

In some embodiments, at least one of the first, second, third, fourth, and fifth wheels may be configured to be rotated about a respective steering axis to permit movement of the modular robotic apparatus in axial, circumferential, and helical directions along the pipe. In one such embodiment, at least one of each such wheel may be configured to freely rotate about its respective steering axis, such that reaction forces applied by the surface of the pipe on the wheel cause the wheel to be rotated about its steering axis into alignment with a corresponding direction of travel of the robotic apparatus along the pipe. In another such embodiment, at least one of each such wheel may be coupled to a steering motor, such that actuation of the steering motor rotates the wheel about its respective steering axis to steer the robotic apparatus in axial, circumferential, and helical directions along the pipe.

In some embodiments, the first and second modules may be configured to decouple from the third module. In one such embodiment, the fourth and fifth modules having at least one dimension or stiffness characteristic differing from that of the first and second clamping members may replace by the first and second modules, respectively, so as to accommodate a second pipe having a different diameter than the pipe and/or to adjust the respective forces applied for urging the respective wheels towards the outer surface of the pipe for securing the robotic apparatus to the pipe. The fourth module, in various embodiments, may include: a sixth wheel and a seventh wheel, and a third clamping member coupling the sixth and seventh wheels and configured to (i) position the sixth wheel on the first circumferential one-third portion of the outer surface of a pipe, (ii) position the seventh wheel on the second circumferential one-third portion of the outer surface of the pipe, and (iii) apply a force for urging the sixth and seventh wheels towards the outer surface of the pipe for securing the robotic apparatus to the pipe; and the fifth module, in various embodiments, may include: an eighth wheel and an nineth wheel, and a fourth clamping member coupling the eighth and ninth wheels and configured to (i) position the eighth wheel on the first circumferential one-third portion of the outer surface of a pipe, (ii) position the nineth wheel on the second circumferential one-third portion of the outer surface of the pipe, and (iii) apply a force for urging the eighth and nineth wheels towards the outer surface of the pipe for securing the robotic apparatus to the pipe.

In some embodiments, the first and second clamping members may be configured to extend around a first portion of the circumference of the pipe, the first portion being less than the full circumference of the pipe, such that the robotic apparatus has an open side through which an obstacle extending from the pipe may pass unobstructed. The first and second wheels, in one such embodiment, may be coupled to first and second ends of the first clamping member, respectively, and the third and fourth wheels may be coupled to first and second ends of the second clamping member, respectively. In another such embodiment, each of the first and second clamping members may include one or more articulated joints and one or more biasing members, the biasing members being configured to generate rotational forces about the one or more articulated joints so as to urge corresponding sections of the respective clamping member towards the surface of the pipe. In yet another such embodiment, each of the first and second clamping members may further include a mechanism configured to adjust a length of the respective clamping member so as to accommodate pipes of different diameters.

Each steering motor, in some embodiments, may be part of a corresponding steering assembly, and each steering assembly may include the steering motor, a frame fixedly coupled to the robotic apparatus, and a steering plate fixedly coupled to the respective wheel and rotationally coupled to the frame so as to permit rotation of the steering plate about the steering axis. In one such embodiment, each steering motor may be fixedly coupled to the respective frame in an orientation configured to be parallel to the pipe, and each steering motor may be coupled to the respective steering plate by a transmission. The transmission, in an embodiment, may include a worm shaft coupled to the respective frame in a position between and in an orientation parallel to the respective steering motor and the respective wheel, the worm shaft having an output coupled to the respective steering plate such that rotation of the worm shaft causes the respective steering plate to rotate about the respective steering axis, and a gear train coupling the respective steering motor output shaft to the worm shaft, such that actuation of the respective steering motor causes rotation of the respective worm shaft.

The robotic apparatus, in some embodiments, may further include a drive assembly associated with each such wheel, each drive assembly having a drive motor and a speed reduction gearbox, the speed reduction gearbox being (i) situated within an interior of the respective wheel and (ii) coupled to an output shaft of the drive motor and the respective wheel such that actuation of the drive motor rotates the respective wheel. Each drive motor, in one such embodiment, may include a rotor and a stator, and each speed reduction gearbox may include a strain wave gearing system, wherein a wave generator is coupled to the rotor of the respective motor, a flex spline is coupled to the respective wheel, and a circular spline is coupled to the stator of the respective motor.

Each drive assembly, in an embodiment, may further include an electrical cable that is flexible in a first direction and substantially inflexible in a second direction perpendicular to the first direction, the electrical cable having: a first end coupled to the respective frame, a second end coupled to the respective drive motor, and an intermediate portion situated within a channel in the steering plate, the intermediate portion being folded over in the first direction within the channel, wherein a length of the intermediate portion situated within the channel is configured to increase or decrease in response to the rotation of the steering plate. The substantial inflexibility of the electrical cable in the second direction may prevent the intermediate portion situated within the channel from bending out of the channel in the second direction, such that the electrical cable does not get caught on surrounding components of the robotic apparatus and/or the pipe. In an embodiment, the directionally flexible electrical cable may be a flexible printed circuit.

In an embodiment, the intermediate portion includes a first intermediate portion extending from the first end and through a guide on the drive motor, and a second intermediate portion extending from the guide and into a channel in the steering plate, where the second intermediate portion then extends along a portion of the channel and doubles back to a hole through the steering plate and through the hole to the second end. Rotation of the steering assembly away from the first end may cause at least a portion of the second intermediate portion situated within the channel to be pulled back through the guide such that the first intermediate portion lengthens to accommodate an increased distance between the first end and the guide, and rotation of the steering assembly towards the first end may cause at least a portion of the first intermediate portion to be routed through the guide and into the channel such that the first intermediate portion shortens to accommodate a decreased distance between the first end the guide.

In another aspect, the present disclosure is directed to another robotic apparatus configured for traversing an outer surface of a pipe. The robotic apparatus, in various embodiments, may include: a first wheel assembly comprising a first wheel, a first drive assembly for driving rotation of the first wheel about a first driving axis, and a first steering assembly for adjusting a direction in which the first wheel is steered; a second wheel assembly comprising a second wheel, a second drive assembly for driving rotation of the second wheel about a second driving axis independent of rotation of the first wheel, and a second steering assembly for adjusting a direction in which the second wheel is steered independent of adjusting the direction in which the first wheel is steered; and a clamping member coupling the first and second wheel assemblies and configured to (i) position the first wheel on a first circumferential half of an outer surface of a pipe, (ii) position the second wheel on a second, opposing circumferential half of the outer surface of the pipe, and (iii) apply a force for urging the first and second wheels towards the outer surface of the pipe for securing the robotic apparatus to the pipe.

The first and second drive assemblies, in various embodiments, each may include a drive motor and a speed reduction gearbox, the speed reduction gearbox being (i) situated within an interior of the respective wheel and (ii) coupled to an output shaft of the drive motor and the respective wheel such that actuation of the drive motor rotates the respective wheel. In one such embodiment, each drive motor may include a rotor and a stator, and each speed reduction gearbox may include a strain wave gearing system, wherein a wave generator is coupled to the rotor of the respective motor, a flex spline is coupled to the respective wheel, and a circular spline is coupled to the stator of the respective motor.

Each of the first and second steering assemblies, in various embodiments, may include a frame fixedly coupled to the clamping mechanism, and a steering plate fixedly coupled to the respective drive assembly and rotationally coupled to the respective frame so as to permit rotation of the steering plate about a steering axis. In one such embodiment, the steering plate may be configured to rotate at least 90 degrees in at least one direction about the respective steering axis, thereby allowing the respective wheel to be steered at least 90 degrees on the surface of the pipe. This may permit movement of the modular robotic apparatus in axial, circumferential, and helical directions along the pipe.

The steering assemblies, in some embodiments, may be configured to rotate about the respective steering axis such that the wheels are oriented to rotate about their drive axes in an circumferential direction along the surface of the pipe, and the drive assemblies may be individually controlled to drive rotation of the respective wheels about their respective driving axes, such that when the wheels make contact with the pipe during the installation, the drive assemblies pull the robotic apparatus in a radial direction onto the pipe, thereby aiding an operator in installing the robotic apparatus onto the pipe.

Each of the first and second steering assemblies, in some embodiments, may further include a steering motor configured to rotate the respective steering plate about the respective steering axis. In one such embodiment, each steering motor may be fixedly coupled to the respective frame in an orientation configured to be parallel to the pipe, and each steering motor may be coupled to the respective steering plate by a transmission. The transmission, in an embodiment, may include: a worm shaft coupled to the respective frame in a position between and in an orientation parallel to the respective steering motor and the respective wheel, the worm shaft being coupled to the respective steering plate such that rotation of the worm shaft causes the respective steering plate to rotate about the respective steering axis, and a gear train coupling the respective steering motor to the worm shaft, such that actuation of the respective steering motor causes rotation of the respective worm shaft.

Each drive assembly, in some embodiments, may further include an electrical cable that is flexible in a first direction and substantially inflexible in a second direction perpendicular to the first direction, the electrical cable having: a first end coupled to the respective frame, a second end coupled to the respective drive motor, and an intermediate portion situated within a channel in the steering plate, the intermediate portion being folded over in the first direction within the channel, wherein a length of the intermediate portion situated within the channel is configured to increase or decrease in response to the rotation of the steering plate. The substantial inflexibility of the electrical cable in the second direction may prevent the intermediate portion situated within the channel from bending out of the channel in the second direction, such that the electrical cable does not get caught on surrounding components of the robotic apparatus and/or the pipe. The directionally flexible electrical cable, in an embodiment, may include a flexible printed circuit.

The intermediate portion, in some embodiments, may include a first intermediate portion extending from the first end and through a guide on the drive motor and a second intermediate portion extending from the guide and into a channel in the steering plate, where the second intermediate portion then extends along a portion of the channel and doubles back to a hole through the steering plate and through the hole to the second end. Rotation of the steering assembly away from the first end may cause at least a portion of the second intermediate portion situated within the channel to be pulled back through the guide such that the first intermediate portion lengthens to accommodate an increased distance between the first end and the guide, and rotation of the steering assembly towards the first end may cause at least a portion of the first intermediate portion to be routed through the guide and into the channel such that the first intermediate portion shortens to accommodate a decreased distance between the first end the guide.

The first and second wheel assemblies, in some embodiments, may be configured to be circumferentially offset from one another by about 180 degrees on the outer surface of the pipe.

The robotic apparatus, in some embodiments, may further include a third freely-rotating wheel coupled to the clamping member. The first wheel assembly, the second wheel assembly, and the third freely-rotating wheel may be configured to be circumferentially offset from one another by about 90 degrees to about 180 degrees on the outer surface of the pipe.

The robotic apparatus, in some embodiments, may further include a third wheel assembly comprising a third wheel, a third drive assembly for driving rotation of the third wheel, and a third steering assembly for adjusting a direction in which the third wheel is steered. The first, second, and third wheel assemblies may be configured to be circumferentially offset from one another by about 90 degrees to about 180 degrees on the outer surface of the pipe.

The clamping member, in some embodiments, may be configured to extend around a first portion of the circumference of the pipe, the first portion being less than the full circumference of the pipe, such that the robotic apparatus has an open side through which an obstacle extending from the pipe may pass unobstructed. In one such embodiment, the first wheel assembly may be coupled to a first end of the clamping member and the second wheel assembly may be coupled to a second end of the clamping member.

The clamping member, in some embodiments, may include one or more articulated joints and one or more biasing members, the biasing members being configured to generate rotational forces about the one or more articulated joints so as to urge corresponding sections of the clamping member towards the surface of the pipe. The clamping member, in an embodiment, may further include a mechanism configured to adjust a length of the clamping member so as to accommodate pipes of different diameters.

In some embodiments, the clamping member may be elastically deformable between a neutral, unloaded state and an expanded, loaded state, and the clamping member may be dimensioned relative to a diameter of the pipe such that the clamping member is in the expanded, loaded state when the first and second wheels are positioned on the outer surface of the pipe, such that the loads urge portions of the clamping member towards the surface of the pipe. The clamping member, in one such embodiment, may further include a mechanism configured to adjust the loads for urging portions of the clamping member towards the surface of the pipe.

### BRIEF DESCRIPTION OF THE DRAWINGS

Illustrative, non-limiting example embodiments will be more clearly understood from the following detailed description taken in conjunction with the accompanying drawings.

FIGS. 1A-1D illustrate perspective, front, and bottom views of a robotic apparatus, in accordance with an embodiment of the present disclosure;

FIG. 2 illustrates the robotic apparatus on a pipe, in accordance with an embodiment of the present disclosure;

FIG. 3A and FIG. 3B illustrate how the wheels can be rotated to push or pull the robotic in a radial direction away or towards the pipe, respectively, in accordance with an embodiment of the present disclosure;

FIG. 4A and FIG. 4B are front and rear perspective views of a wheel assembly, in accordance with an embodiment of the present disclosure;

FIG. 5 is a side cutaway view of a drive assembly, in accordance with an embodiment of the present disclosure;

FIG. 6 is a perspective view of a portion of a steering assembly, in accordance with an embodiment of the present disclosure;

FIG. 7 illustrates a steering plate as coupled to a drive assembly and a wheel, in accordance with an embodiment of the present disclosure;

FIG. 8 is a side cutaway view of the portion of the steering assembly shown in FIG. 6, in accordance with an embodiment of the present disclosure;

FIG. 9 is an alternate view of the assembly shown in FIG. 7, altered to highlight a directionally flexible electrical cable thereof, in accordance with an embodiment of the present disclosure; and

FIGS. 10A-10C illustrate how the directionally flexible electrical cable moves as the assembly of FIG. 9 is rotated throughout its steering range, in accordance with an embodiment of the present disclosure.

### DETAILED DESCRIPTION

Embodiments of the present disclosure are directed to a low-clearance robotic apparatus for traversing the exterior of piping systems, such as ones commonly found in chemical plants, power plants, manufacturing plants, and infrastructure. Piping systems can be complex and present various obstacles that can make it difficult to traverse individual pipes in an efficient and effective manner. Representative obstacles may include supports, junctions, flanges, valves, vents, or bleeders (similar to smaller valves), changes in diameter, and bends, amongst others such as nearby pipes and other nearby structures. Various embodiments of the robotic apparatus may be configured to traverse pipes 10 and navigate such obstacles as encountered through a unique architecture and approach, as later described in more detail. The robotic apparatus may also be adapted to traverse the exterior of other structures that are similarly shaped, such as structural cables (e.g., on suspension bridges), structural beams, powerlines, underwater cables, and underwater piping systems.

Embodiments of the present disclosure may be useful in many applications including, without limitation:
Pipeline inspection using cameras, non-destructive testing (NDT or NDI), or other sensors;
Inspecting equipment in the vicinity of the piping system
Performing maintenance on the piping system (e.g., cleaning the external surface, removing insulation, applying a patch/clamp to stop a leak)
Transporting tools or equipment along the piping system (e.g., facilitating installation of sensors on the pipe).

Various embodiments of the robotic apparatus may be capable of traversing pipes arranged in any orientation (including horizontal and vertical), and pipes made of any material (e.g., steel, aluminum), even those with insulation about the exterior of the pipe. Insulation is typically a semi-rigid material, such as a mineral wool or calcium silicate, protected by a thin metal jacket, such as aluminum or stainless steel. For clarity, the outer surface of any insulation on the exterior of a pipe may, for simplicity, be referred to as the outer surface of the pipe. As such, references herein to the robotic apparatus being positioned on, secured to, contacting, or otherwise interfacing with the outer surface of a pipe should not be strictly construed as referring only to interfacing with the metal exterior of the pipe under such insulation, but rather may additionally or alternatively encompass the robotic apparatus being positioned on, secured to, contacting, or otherwise interfacing with the outer surface of the insulation on the exterior of the pipe. Simply stated, references to the outer surface of the pipe should be construed as the outer surface of insulation on the pipe when discussing the robotic apparatus in the context of traversing insulated pipes.

Generally speaking, embodiments of the robotic apparatus of the present disclosure may attach to a pipe by applying a clamping force on the pipe. Various embodiments may be capable of holding a static position on the pipe and may support its own weight on a range of pipe sizes in any orientation (e.g., horizontal, or vertical). The robotic apparatus, in various embodiments, may be configured to drive along paths in the longitudinal direction of the pipe (sometimes referred to herein as axial translation), in a circumferential direction on the pipe (sometimes referred to herein as circumferential translation), along a helical path (i.e., a combination of circumferential and longitudinal vectors), and various combinations thereof, on pipes of varying sizes and orientation. Such maneuvering, in combination with the ability to expand or contract the clamping arm around the pipe, and the robots low-profile and open-sided architecture, may allow the robotic apparatus to navigate a variety of bends and obstacles encountered along the length of the pipe.

A low profile of the robotic apparatus may enable it to drive along pipes in close proximity to other pipes or obstacles situated close by. Many such pipes are often installed with only a few inches of space between them. Various embodiments of the robotic apparatus may include wheel assemblies comprising a unique packaging of drive and steering elements that require a minimal amount of clearance around the pipe, while also enabling the robot apparatus to drive in any direction along the surface and providing enough torque and speed to propel the robot apparatus and its payload on both vertical and horizontal pipes, as further described in more detail below.

The robotic apparatus may additionally be capable of actively controlling the amount of clamping force it exerts on the pipe, thereby allowing the robot to selectively apply more clamping force in situations where additional traction is desired (e.g., while climbing or remaining stationary a vertical pipe) and selectively apply less clamping force in situations where less traction is desired (e.g., while traversing a horizontal pipe), which can help reduce power consumption and thus battery size, motor size, and associated weight. Active control of clamping force can also help ensure that the robotic apparatus does not damage the pipe or insulation. Further, the robotic apparatus may be capable of actively sensing whether the wheels slip on the pipe surface and actively control individual wheels to steer the robotic apparatus back to the centerline of the pipe.

The robot, in various embodiments, may have a modular architecture in which various components can be added, removed, or replaced with similar components having different properties. Such modularity can allow the robotic apparatus to be reconfigured in the field as needed to adapt to different operating conditions, such as for operation on pipes of varying sizes (diameter) and orientations (e.g., horizontal, vertical), and to carry different payloads (e.g., inspection sensors, batteries).

In various embodiments, the robotic apparatus may be configured to carry and deploy a payload along the pipe, such as cameras (e.g. visual spectrum and IR cameras), various sensors like NDT sensors (e.g., ultrasonic testing probes, pulsed eddy current probes, digital radiography equipment, acoustic sensors) and gas monitors for the purpose of inspecting the piping system or equipment in its vicinity, and/or other payloads like tools and equipment. The robotic apparatus, in various embodiments, may include an onboard power supply (e.g., batteries) and operate via wireless communication with an operator, thereby obviating the need for a power cord or tether. Of course, in various embodiments, the robotic apparatus may utilize a power cord (or other suitable power source) and/or wired communication (or other suitable communications means). Such a configuration may be advantageous in certain cases, such as if one or more components of a particular payload (e.g., an NDT instrument) is too large to be carried onboard while maintaining the robot's low profile as described herein. In such an example, the NDT probe could be located onboard the robotic apparatus and connected to the NDT instrument on the ground with the operator via a power cord and/or tether.

### Robotic Apparatus 1000

### High-Level Architecture

Robotic apparatus 1000, in various embodiments, may be based in part on designs shown and described in U.S. patent application Ser. No. 18/198,422, entitled “Modular Pipe Traversing Apparatus” filed May 17, 2023, which is incorporated herein by reference for all purposes, and in particular robotic apparatus 200 thereof. While certain components may be the same or similar as their counterparts in the aforementioned patent application, several may differ especially in the context of the wheels used, as well as the manner in which steering and/or drive components are packaged with such wheels to provide a high-torque, low-clearance design.

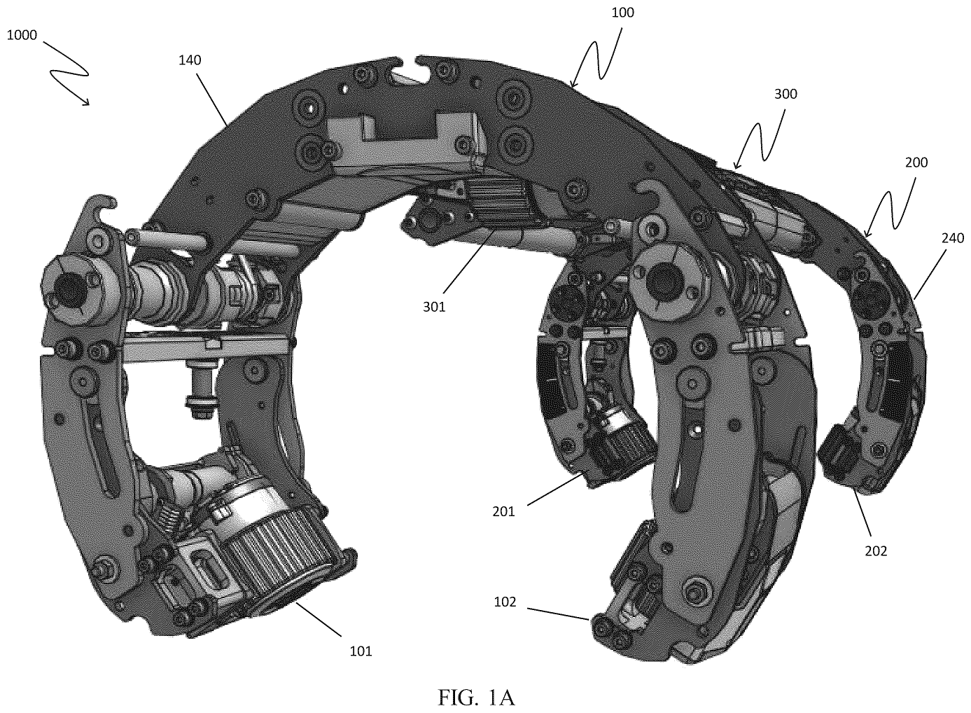

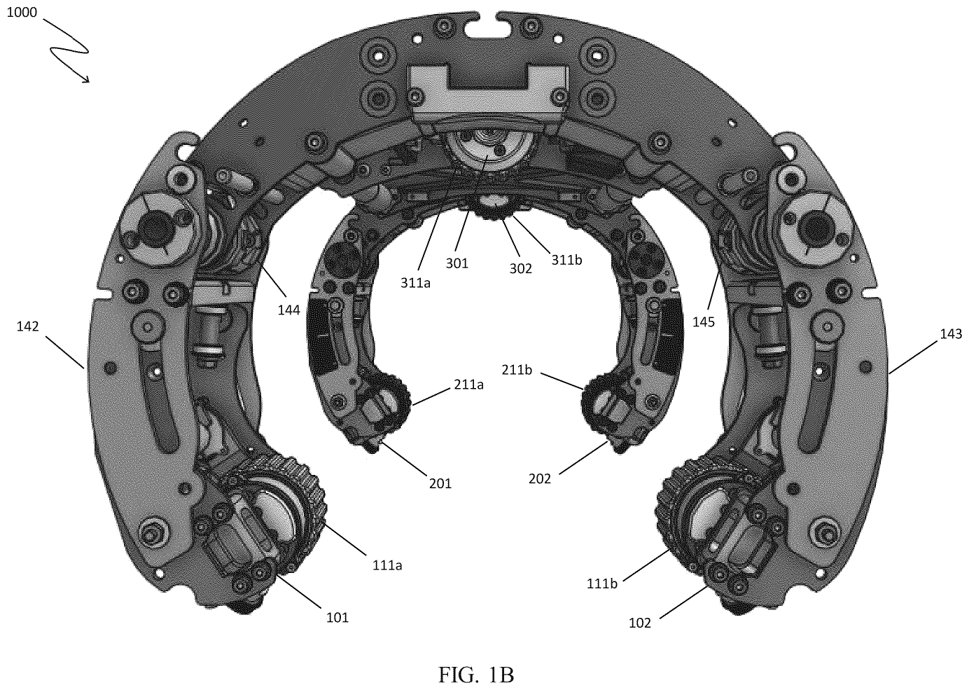

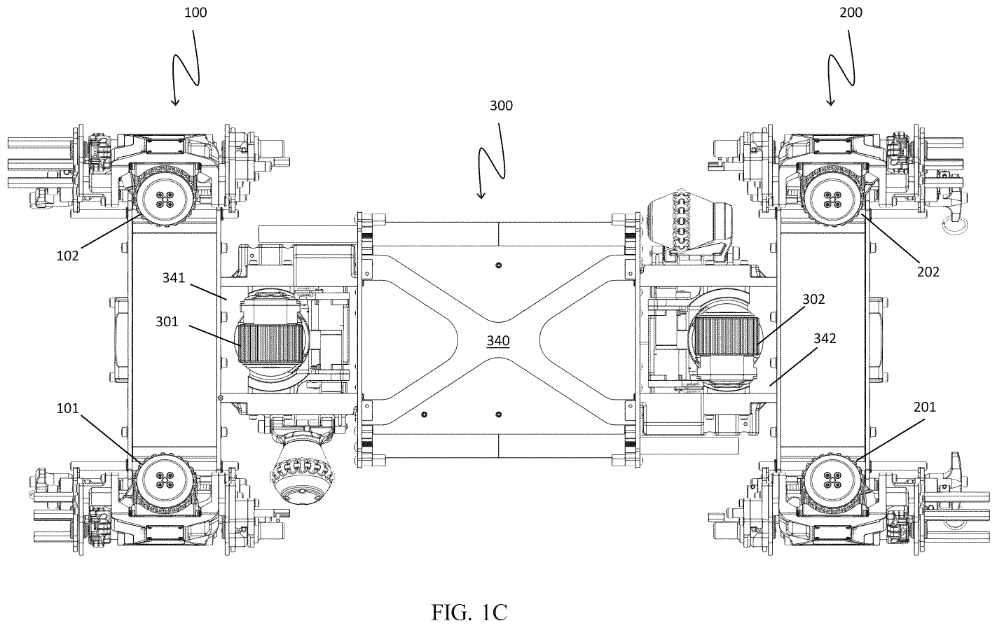

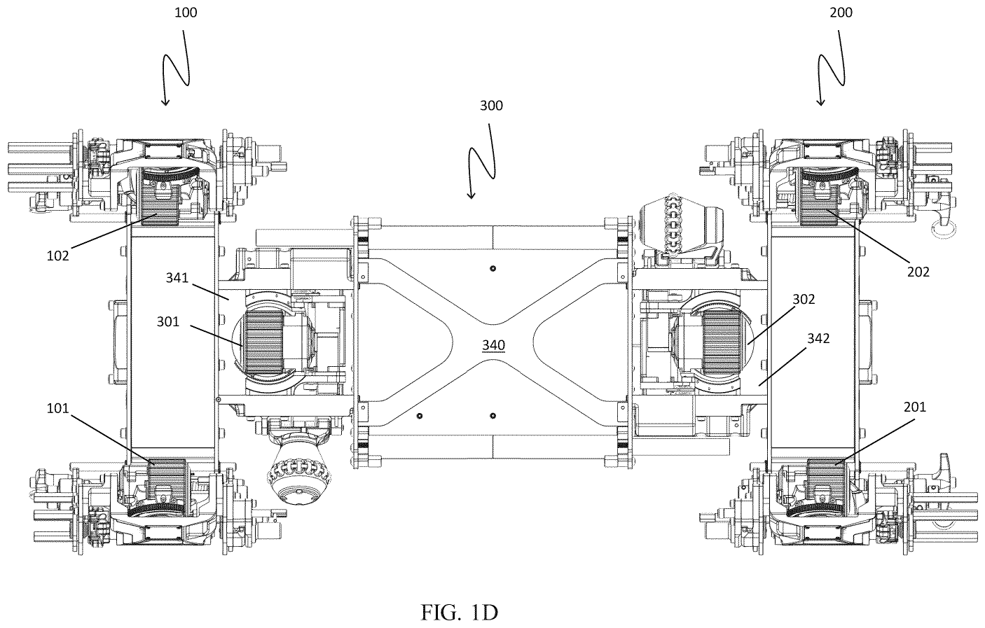

FIGS. 1A-1D illustrate perspective, front, and bottom views of a representative embodiment of robotic apparatus 1000. As shown in FIGS. 1A-1D, robotic apparatus 1000 of the present disclosure may generally include a first module 100 and a second module 200 connected by a third module 300 as described in more detail below.

Module 100 and module 200, in various embodiments, may each include two or more wheel assemblies. In the embodiment shown, module 100 includes two wheel assemblies 101, 102 and module 200 includes two wheel assemblies 201, 202. Wheel assemblies 101, 102, in various embodiments, may be coupled by a clamping member 140. Clamping member 140, in various embodiments, may be configured to: (i) position wheel 111a (later described) of wheel assembly 101 on a first circumferential one-third portion of the outer surface of pipe 10, (ii) position wheel 111b (later described) of wheel assembly 102 on a second circumferential one-third portion of the outer surface of pipe 10, and (iii) apply a force for urging wheels 111a, 111b of wheel assemblies 101, 102 respectively towards the outer surface of pipe 10 for securing robotic apparatus 1000 to pipe 10. Likewise, wheel assemblies 201, 202, in various embodiments, may be coupled by a clamping member 240. Clamping member 240, in various embodiments, may be configured to: (i) position wheel 211a (later described) of wheel assembly 201 on a first circumferential one-third portion of the outer surface of pipe 10, (ii) position wheel 211b (later described) of wheel assembly 202 on a second circumferential one-third portion of the outer surface of pipe 10, and (iii) apply a force for urging wheels 211a, 211b of wheel assemblies 201, 202 respectively towards the outer surface of pipe 10 for securing robotic apparatus 1000 to pipe 10.

Clamping members 140, 240, in various embodiments, may be configured to extend around a portion of the circumference of pipe 10, such that robotic apparatus 1000 has an open side through which an obstacle extending from pipe 10 may pass unobstructed as robotic apparatus traverses pipe 10. In one such embodiment, wheel assemblies 101, 102 may be coupled to first and second ends of clamping member 140 respectively, and wheel assemblies 201, 202 may be coupled to first and second ends of clamping member 240 respectively, as shown. Clamping members 140, 240, in various embodiments, may have architectures and properties similar to those described in the context of the clamping members described in the aforementioned patent application. For example, as shown in FIG. 1B of the present disclosure, clamping members 140, 240 may include one or more articulated joints and one or more biasing members 144, 145, the biasing members 144, 145 being configured to generate rotational forces about the one or more articulated joints so as to urge corresponding sections 142, 143 and 242, 243 (not shown) towards the surface of the pipe 10. As another example (not shown), clamping members 140, 240 may be one piece each and elastically deformable between a neutral, unloaded state and an expanded, loaded state, wherein the clamping member 140, 240 is dimensioned relative to the diameter of the pipe 10 such that it is in the expanded, loaded state when wheels 111a, 111b and wheels 211a, 211b are positioned on the outer surface of pipe 10, such that the loads urge portions of the clamping members 140, 240 towards the surface of the pipe 10. In an embodiment, such clamping members 140, 240 may further comprise a mechanism configured to adjust the loads for urging the portions of the clamping members 140, 240 towards the surface of the pipe 10. Additionally, or alternatively, clamping members 140, 240, in an embodiment, may include a mechanism configured to adjust the length of the clamping members 140, 240 so as to accommodate pipes of different diameters.

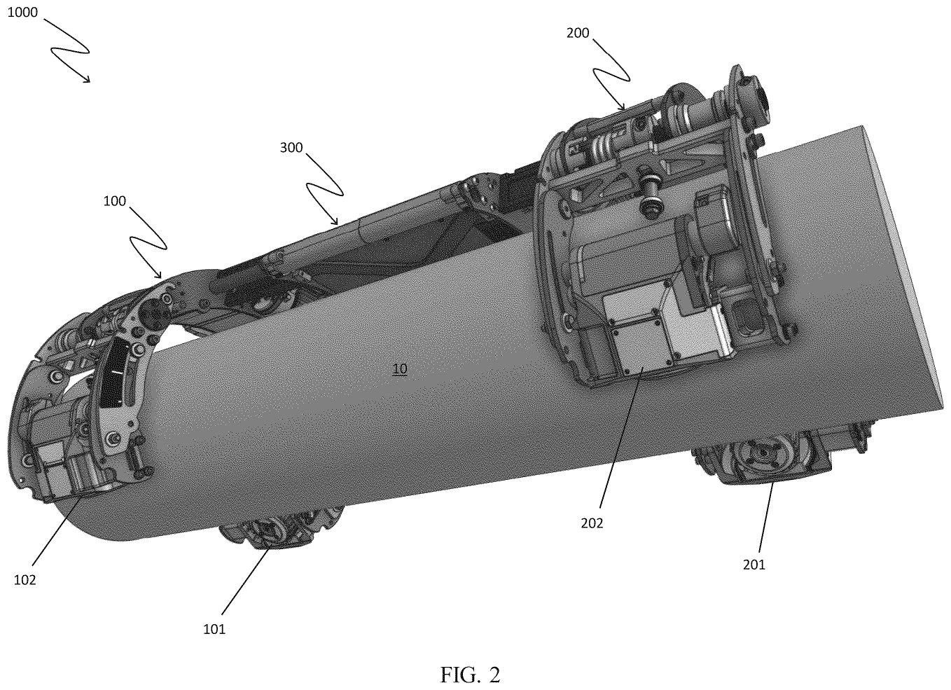

Module 300, in various embodiments, may include one or more wheel assemblies. In the embodiment shown, module 300 includes two wheel assemblies 301, 302. Module 300 may further include a connecting member 340 having a first end 341 coupled to module 100 and a second end 342 coupled to module 200 so as to (i) position wheel 311a (later described) of wheel assembly 301 and wheel 311b (later described) of wheel assembly 302 on a third circumferential one-third portion of the outer surface of the pipe, and (ii) position first module 100 and second module 200 at different axial positions along a length of pipe 10, as shown in FIG. 2. Connecting member 340, in various embodiments, may further provide an area on which to mount electronics necessary for powering and controlling robotic apparatus 1000 and other payloads.

In some embodiments, module 100 and module 200 may be configured to decouple from connecting member 340 of module 300 while, in other embodiments, module 100 and module 200 may not be configured to decouple from connecting member 340 of module 300. In some embodiments, modules 100, 200 may be configured to decouple from connecting member 340 and be replaced with fourth and fifth modules 400, 500 having clamping members 440, 540 with at least one dimension or stiffness characteristic differing from that of first and second modules 100, 200 so as to accommodate a pipe 10′ of different diameter than pipe 10 and/or to adjust the respective forces applied for urging the respective wheels towards the outer surface of pipe 10 for securing the robotic apparatus to pipe 10. As described in above-referenced patent application, robotic apparatus 1000 may also carry various payloads and sensors, and it can be equipped with the same type of “fail-safe” arms, even though some of these features are not shown in the present disclosure.

Wheels 111, 211, 311, in various embodiments, may comprise a rim and a tire. The tire may be made of any material suitable for achieving high traction, such as a rubber or urethane material, but can be made of other materials to fit the use case.

Wheel assemblies, in various embodiments, may each be configured to permit movement of robotic apparatus 1000 in axial, circumferential, and helical directions along pipe 10. The wheels 111, 211, 311 achieve traction on the surface of pipe 10 through the clamping force generated by clamping members 140, 240, 340 and the friction provided by the tires. Robotic apparatus 1000 can drive in an axial direction along pipe 10 by rotating wheels 111, 211, 311 about their steering axes to the orientation shown in FIG. 1A and FIG. 1C (i.e., with the wheels oriented to rotate about their drive axes in an axial direction along pipe 10). Robotic apparatus 1000 can drive in a circumferential direction along pipe 10 by rotating wheels 111, 211, 311 about their steering axes to the orientation shown in FIG. 1B and FIG. 1D (i.e., with the wheels oriented to rotate about their drive axes in a circumferential direction along pipe 10). Robotic apparatus 1000 can drive along pipe 10 in a direction with both axial and circumferential vector components by rotating wheels 111, 211, 311 about their steering axes to some intermediate angle between those described above. For example, if wheels 111, 211, 311 are steered 45 degrees from their neutral (axial) steering angle robotic apparatus 1000 will drive in a helical path around pipe 10.

The driving path can be optimized by a human user or a computer program to drive robotic apparatus 1000 to where it needs to go along pipe 10, to collect data, or to drive around obstacles by letting them pass through the open side of the robot (i.e., the collective space spanning between the wheel assemblies 101, 102, 201, 202 towards the bottom of FIG. 1B).

In addition to driving along the surface of pipe 10, the wheel assemblies can also be used to move robotic apparatus 1000 in and out from the surface of pipe 10—that is, move robotic apparatus 1000 radially with respect to pipe 10. This can be done in isolation or in combination with the other types of motion previously described. Driving in or out from the surface of pipe 10 can be advantageous if robotic apparatus 1000 is starting to slip off the surface of pipe 10.

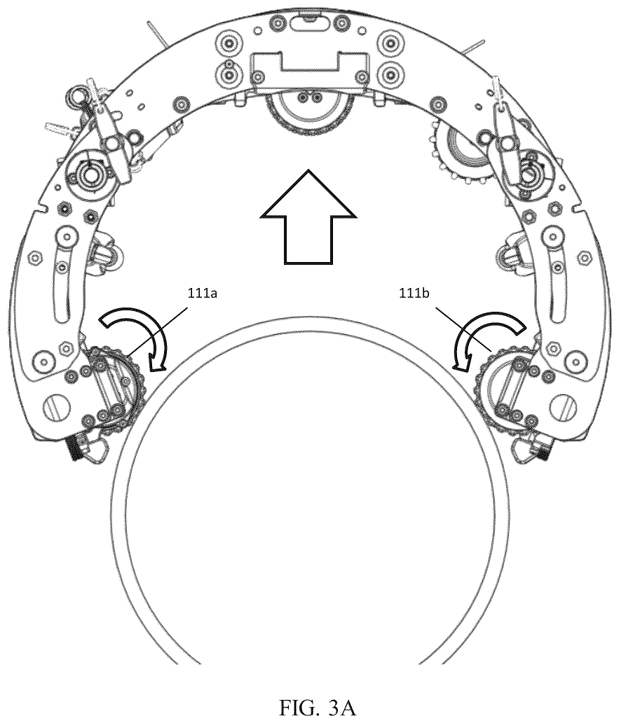

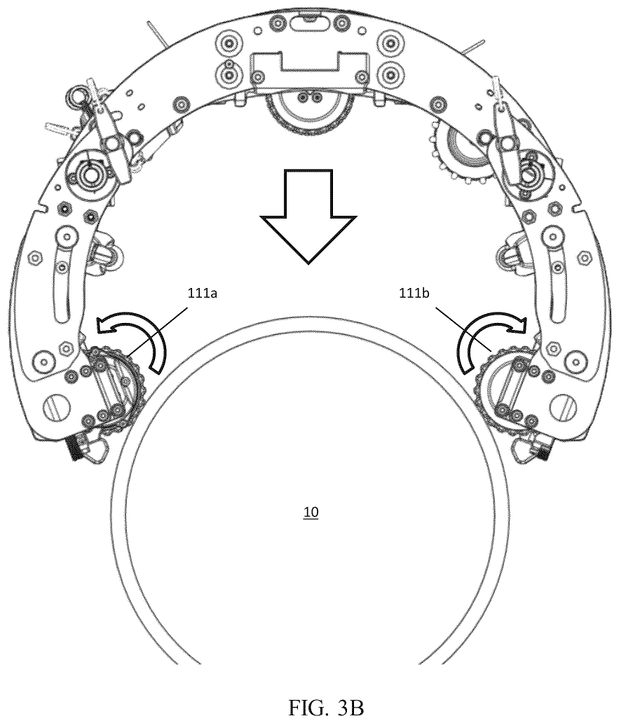

FIG. 3A and FIG. 3B can be used to illustrate this principle. Referring first to FIG. 3A, with wheels 111, 211 oriented in these directions, if wheels 111a and 211a turn clockwise and wheels 111b and 211b turn counter-clockwise, robotic apparatus 1000 will drive radially away from the pipe 10 as shown by the upward pointing directional arrow. Conversely, with reference to FIG. 3B, if wheels 111a and 211a turn counter-clockwise and wheels 111b and 211b turn clockwise, robotic apparatus 1000 will drive radially towards the pipe 10 as shown by the downward pointing directional arrow.

Driving in or out from the surface of pipe 10 can also be advantageous for installing or removing robotic apparatus from pipe 10. When the operator installs the robotic apparatus 1000 onto pipe 10, they hold the robotic apparatus 1000 with the open side against pipe 10 and the operator pushes the robotic apparatus 1000 towards the pipe 10. The clamping forces exerted by clamping members 140, 240 oppose the movement of robotic apparatus 1000 against the pipe 10 as the clamping forces are urging the wheels together in a direction that closes the gap on the open side of the robotic apparatus 1000. The wheels can be driven as shown in FIG. 3B to pull robotic apparatus 1000 radially towards pipe 10 to assist the operator in overcoming this opposing force during installation. Conversely, the operator can drive the wheels as shown in FIG. 3A to push robotic apparatus 1000 radially away from pipe 10 to assist the operator in removing robotic apparatus from pipe 10.

### Wheel Assemblies

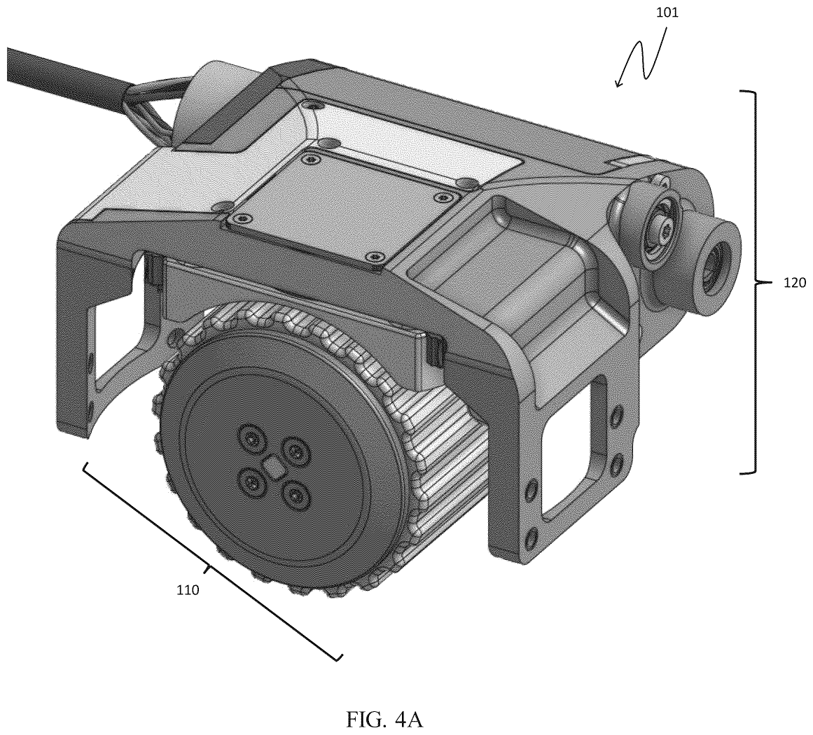

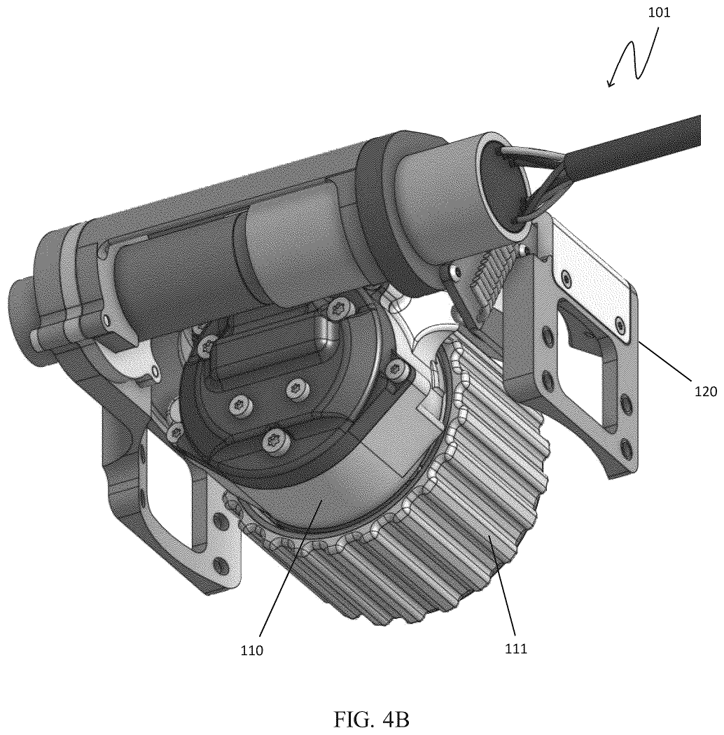

FIGS. 4A-10C illustrate various views of a representative embodiment of wheel assembly 101 of the present disclosure. Generally speaking, as shown in the front and rear perspective views of FIG. 4A and FIG. 4B, wheel assembly 101 may include a wheel 111, a drive assembly 110 for driving rotation of wheel 111, and a steering assembly 120 for adjusting a direction in which wheel 111 is steered, as later described in more detail. Both drive assembly 110 and steering assembly 120 and the overall mechanical structure may be designed to fit within a compact form factor that requires minimum clearance from the surface of the pipe. The embodiment shown in FIGS. 4A and 4B is designed to fit within 2.4 inch clearance from the surface of the pipe. It provides 95° steering angle in one or both directions from the neutral (axial) direction. The wheel 111 can drive at 6 inches per second along the pipe 10 and provide 15.2 Nm of torque. The same general wheel design can be used for any of the wheels on the robotic apparatus 1000.

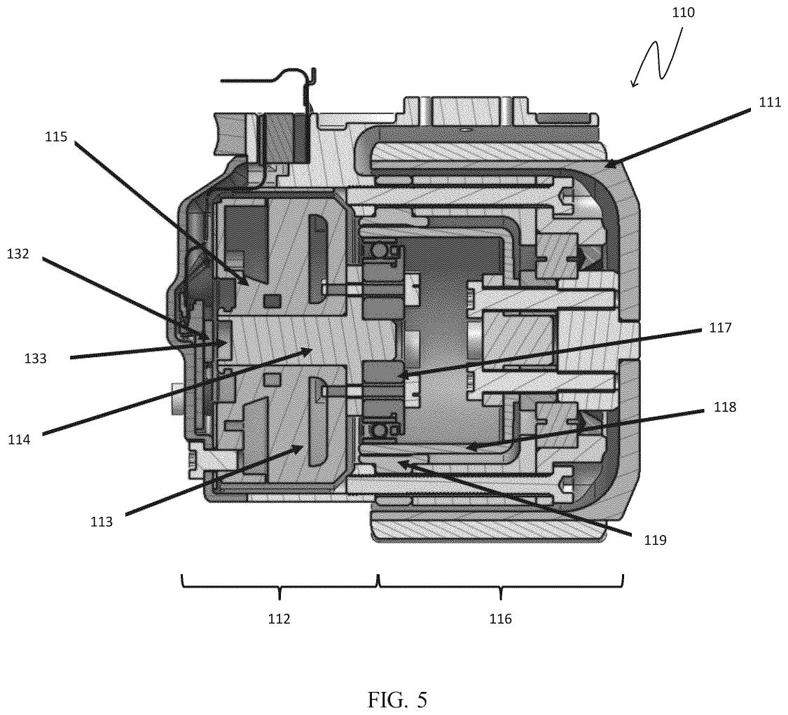

FIG. 5 is a side cutaway view of drive assembly 110 of this representative embodiment of wheel assembly 101. Drive assembly 110, in various embodiments, may be packaged at least partially within wheel 111, thereby helping to minimize the overall size of wheel assembly 101 which, in turn, reduces the clearance required for robotic apparatus 1000 to navigate past obstructions adjacent to pipe 10. Furthermore, such packaging may provide for use of a larger motor/drivetrain than that which can be used with many other wheels of comparable size that require thicker rims, such as mecanum wheels (these are thicker to accommodate the rollers). This, in turn, maximizes the amount of torque and power available for driving wheel 111 along the surface of pipe 10, and larger diameter motors/drivetrains can typically operate a higher efficiencies. In the embodiment shown, a portion of drive assembly 110 is packaged within the interior of wheel 111, with the remainder extending further outside of wheel 111. It should be recognized that this is merely one possible configuration—in various embodiments (not shown), a portion or the entirety of drive assembly 110 can be packaged within the interior of wheel 111. One having ordinary skill in the art will recognize suitable combinations of wheel width and drive assembly 120 length for a given application and, as such, the present disclosure is not intended to be limited to any one such configuration.

Drive assembly 110, in various embodiments, may generally include a motor 112 and a speed reduction gearbox 116. Motor 112, in various embodiments, may include any motor suitable for generating sufficient power to drive wheel 111 such as an electric outrunner motor. If the electric motor is a brushless motor, it may have built-in commutation sensors, or a magnet 133 can be attached to the output shaft 114 and an external magnetic position sensor 132 can be used to provide commutation signals, as shown. Persons having ordinary skill in the art will understand how to control an electric motor, whether brushed or brushless. In wheeled robots, the drive wheels generally operate at higher torque and lower speed than what electric motors typically output, unlike aerial robots using propellers for example. Accordingly, in the present embodiment, motor 112 is coupled to speed reduction gearbox 116 to reduce the overall output speed of motor 112 and increase overall output torque of drive assembly 110. Several different kinds of gearboxes can be used for this purpose, but an example is a strain wave gearing system like the one shown in FIG. 5. Some benefits of strain wave gearing include high gear ratios, high torque capability, and a compact coaxial design. A cycloidal drive is a similar gearing system that could be used as well.

In this embodiment, rotor 113 of motor 112 couples to the wave generator 117 of speed reduction gearbox 116 via output shaft 114 of motor 112 and stator 115 of motor 112 couples to circular spline 119 of speed reduction gearbox 116. Wave generator 117 acts on the flex spine 118 of speed reduction gearbox 116 which in turn rotates against the static circular spline 119 of speed reduction gearbox 116. Flex spine 118 drives the output of the gear set, which is coupled to the rim and tire of wheel 111. In this embodiment, the number of teeth on flex spine 118 and circular spline 119 define a gear reduction of 100:1. Additional parts such as bearings, alignment shafts, and retaining rings may be used to locate and attach parts, transfer loads, and make the assembly work as intended. The details of the implementation can be derived from the figures provided and general knowledge of how a gearing system works.

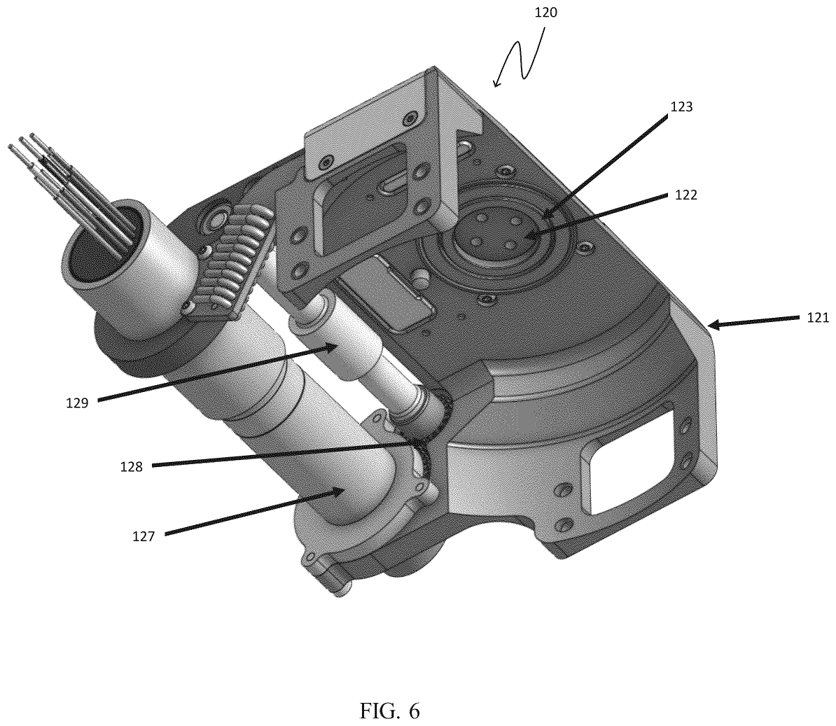

FIG. 6 is a perspective view of a portion of steering assembly 120 of this representative embodiment of wheel assembly 101. Steering assembly 110, in various embodiments, may generally include a frame 121 on which to mount a steering motor 127 and a steering plate 124 (later shown and described). Generally speaking, steering motor 127 may be fixedly coupled to frame 121 and steering plate 124 may be rotatably coupled to frame 121, and an output of steering motor 127 coupled to an input of steering plate such that steering motor 127 can control rotation of steering plate 124 about a steering axis. Steering plate 124 is also fixedly coupled to drive assembly 110 such that rotating steering plate 124 about the steering axis steers wheel 111 in turn. Frame 121 can be fixedly mounted to the main structure of robotic apparatus 1000 (e.g., frames 121a, 121b to clamping member 140 in the context of wheel assemblies 101, 102; frames 221a, 221b to clamping member 240 in the context of wheel assemblies 201, 202; frames 321a, 321b to connecting member 340 in the context of wheel assemblies 301, 302).

Frame 121, in various embodiments, may include a mounting plate 122 and bearing 123 to provide the rotational coupling between frame 121 and steering plate 124. Steering motor 127, in various embodiments, may be fixedly coupled to frame 121 proximate to mounting plate 122 and bearing 123, but with enough clearance to avoid interfering with rotation of drive assembly 110 and wheel 111 about the steering axis as described herein. In some embodiments, steering motor 127 may be coupled to frame 121 such that steering motor 127 is oriented parallel to pipe 10 when robotic apparatus 1000 is secured thereon. This helps minimize the overall form factor of wheel assembly 101 and thereby reduces the amount of clearance necessary for robotic apparatus to navigate past obstacles adjacent to pipe 10. As configured, the output of steering motor 127 may not align directly with the input of steering plate 124 though; in such cases, a transmission may be used to couple the two. In the embodiment shown, the output of steering motor 127 couples to a geartrain 128 of two spur gears which, in turn, couple to an input of a worm shaft 129. An output of the worm shaft 129 then couples to the input of the steering plate 124, thereby allowing actuation of steering motor 127 to rotate steering plate 124 about the steering axis. In an embodiment, steering motor 127 could drive worm shaft 129 directly, but geartrain 128 allows steering motor 127 and worm shaft 129 to be packaged next to each other, instead of being axially aligned, and allows steering motor 127 to be placed closer to the surface of the pipe.

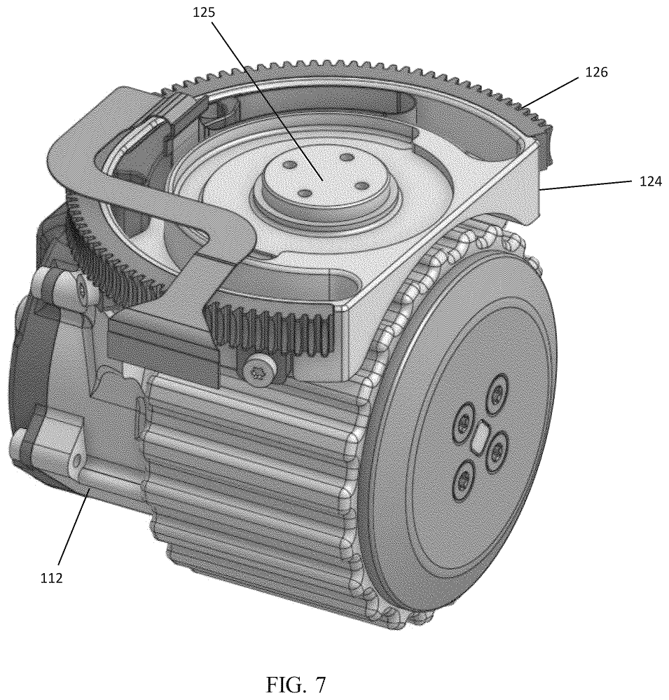

FIG. 7 illustrates steering plate 124 as coupled to drive assembly 110 and wheel 111. Steering plate 124, in various embodiments, may include a mounting section 125 configured to couple to mounting plate 122 and bearing 123 on frame 121, thereby rotatably coupling steering plate 124 to frame 121. Steering plate 124, in various embodiments, may have a curved outer perimeter with gear teeth 126 or other suitable structure or mechanism for coupling to the output of steering motor 127 (e.g., a worm wheel section 126 configured to couple to worm shaft 129). As configured, actuation of steering motor 127 causes steering plate 124 to rotate about its steering axis. As previously noted, steering plate 124 may be fixedly coupled to drive assembly 110 such that drive assembly and wheel 111 rotate about the steering axis in turn.

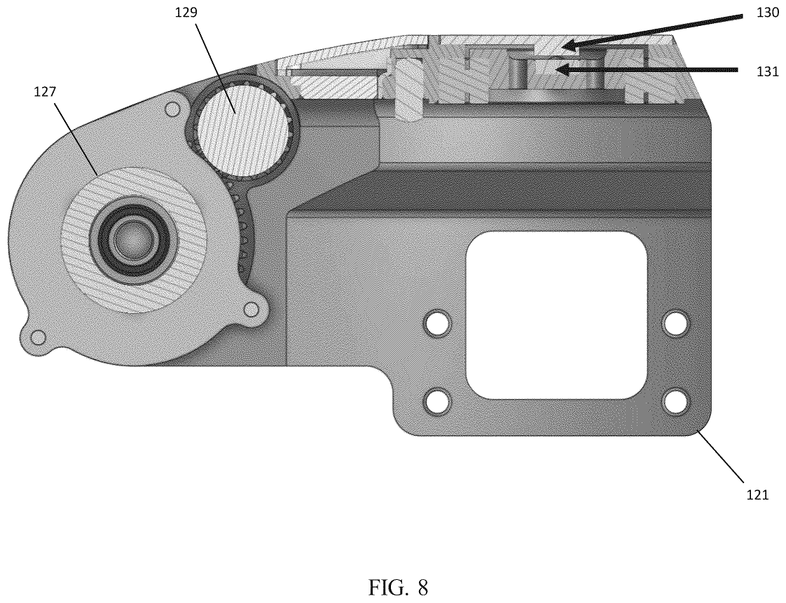

FIG. 8 is a side cutaway view of the portion of steering assembly 120 shown in FIG. 6. To enable closed-loop feedback of the steering angle, another magnet 131 and position feedback sensor 130 can be used. Sensor 130 may communicate with a processor, such as a microcontroller, which would in turn control the steering motor 127 to achieve the desired steering angle.

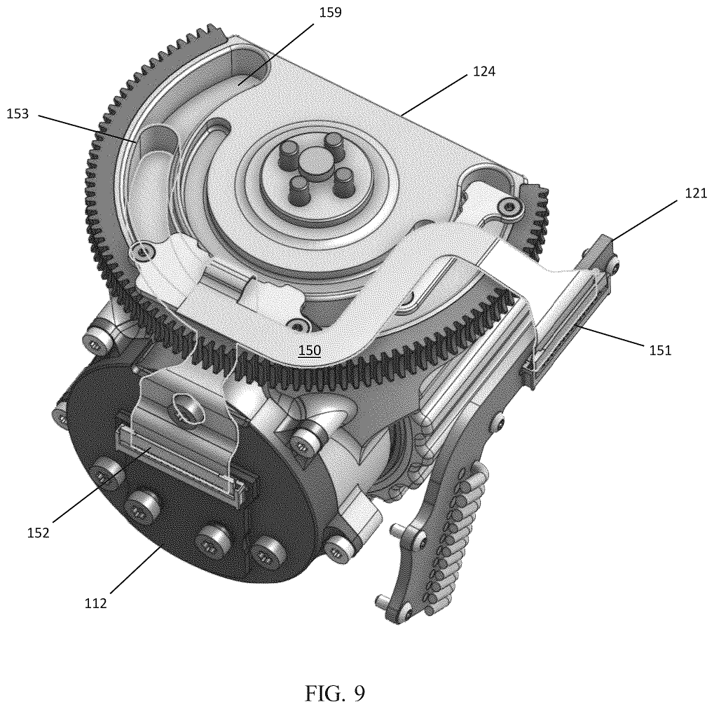

A challenge presented by the design of wheel assemblies described herein is how to route electrical signals for power and control of drive motor 112. Drive assembly 110, in various embodiments, can travel a full 190 degrees (plus or minus 95 degrees from neutral)—as configured, a traditional cable would need a lot of additional length (service loop) on one end of the travel in order to not get overextended at the other end of the travel. This additional length is hard to manage, and it can easily get caught in the steering assembly or on other objects as robotic apparatus 1000 travels along pipe 10. FIG. 9 is an alternate view of the assembly shown in FIG. 7, altered to highlight an embodiment of a directionally flexible electrical cable 150 designed to address this issue.

Directionally flexible electrical cable 150, in various embodiments, may comprise a collection of electrical conductors (e.g., cable) that is flexible in a first direction and substantially inflexible in a second direction perpendicular to the first direction. For example, in an embodiment, directionally flexible electrical cable 150 may be substantially ribbon shaped (flat and wide) and flexible in response to forces applied in the thickness direction and inflexible in response to forces applied in the widthwise direction by virtue of its significant width. In various embodiments, directionally flexible electrical cable 150 may be a flexible printed circuit board (also known as a “flex PCB” or FPC), which is an electrical circuit in a flexible plastic substrate.

Directionally flexible electrical cable 150, in various embodiments, may be considered part of drive assembly 110 and may include a first end 151 coupled to frame 121 (where it connects to electrical conductors on the main structure of robotic apparatus 1000) and a second end 152 coupled to drive motor 112. An intermediate portion 153 of directionally flexible electrical cable 150 may be routed from first end 151 into a channel 159 in steering plate 124, where it is folded over on itself (i.e., doubles back) in the direction in which it is flexible, and then routed through a hole in steering plate 124 to where second end 152 couples to drive motor 112. As configured, an effective length of the intermediate portion 153 situated within channel 159 may be configured to increase or decrease in response to rotation of steering plate 124 about the steering axis and the substantial inflexibility of directionally flexible electrical cable 150 in the second direction prevents the intermediate portion 153 from bending out of the channel 159 in the second direction. This helps prevent directionally flexible electrical cable 150 from getting caught on surrounding components of the robotic apparatus 1000 and/or pipe 10, while allowing steering plate 124 to rotate throughout its full range.

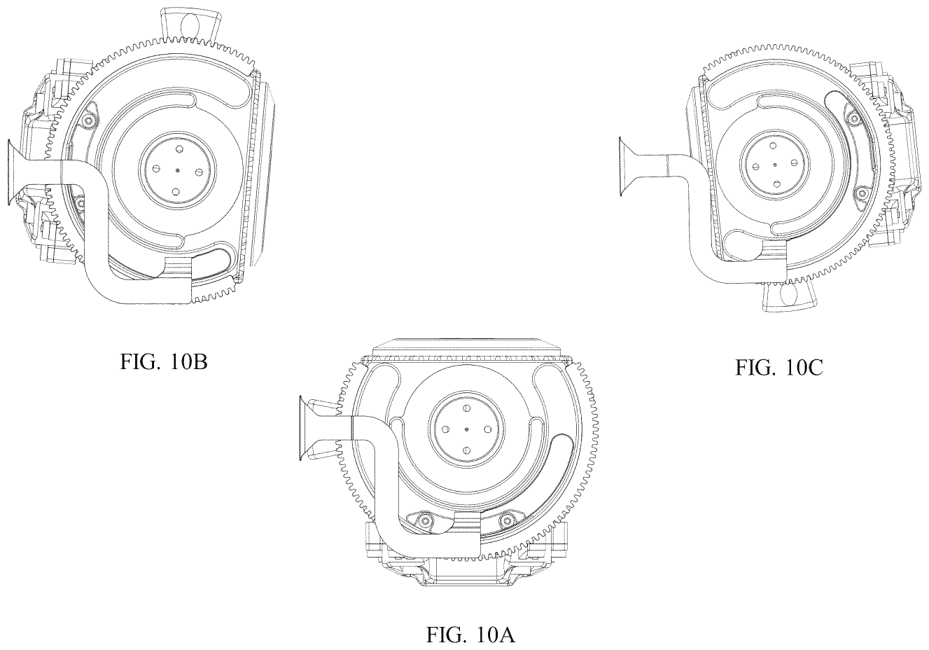

FIGS. 10A-10C illustrate how the directionally flexible electrical cable 150 moves as the assembly of FIG. 9 is rotated throughout its steering range. In particular, FIG. 10A, FIG. 10B, and FIG. 10C illustrate directionally flexible electrical cable 150 when steering plate 124 is at a neutral (axial) steering angle, steered all the way to the right, and steered all the way to the left, respectively. As shown, the length of intermediate portion 153 in channel 159 changes as the assembly steers throughout this range. When the assembly is steered rightward, as shown in FIG. 10B, intermediate portion 153 shortens and when the assembly is steered leftward, as shown in FIG. 10C, intermediate portion 153 lengthens.

Integrating wheel assemblies of this kind into the design of robotic apparatus 1000 has several advantages relative to other wheel designs including wheels with rollers:

(1) In both wheel designs the drivetrain (motor and gear reduction) is typically fitted inside the wheel for a compact form factor. For wheels of comparable size, the swerve drive wheel can fit a larger diameter drivetrain inside compared to the wheels with rollers, since the latter require a thicker rim around the wheel for the rollers. The larger diameter drivetrain can produce higher torque and power. The larger diameter drivetrain can typically also operate at higher efficiency.

(2) Wheels with rollers, such as mecanum wheels, typically operate in pairs and achieve motion in any direction by selectively cancelling out components of their thrust vectors with each other to achieve the desired net thrust vector. This principle achieves motion in any direction along the driving surface with a relatively simple mechanical design, but a lot of thrust and power is lost internally in that system to cancel out thrust components. One swerve drive wheel generally replaces two mecanum wheels, but achieves higher thrust and efficiency in a similar form factor.

(3) When encountering an uneven surface or various obstacles along the pipe, the swerve drive wheels can climb over these obstacles more consistently. The main reason for this is that the swerve drive wheels are always turned in the direction they are driving and as they hit obstacles, they are rolling over them in the most advantageous direction. In contrast, the wheels with rollers may encounter obstacles from any direction relative to the major diameter of the wheel. In many cases, this means that the wheel is not rolling over the obstacle in its most advantageous direction and more easily gets stuck.

(4) Swerve drive wheels can be fitted with rims that are easily replaceable and can be designed with different tread patterns for different use cases. For example, a deeper tread pattern can be used when driving on pipes with soft surfaces (e.g., wax tape wraps) and a smooth tire can be used when driving directly on metal or plastic surfaces. Wheels with rollers can generally not use any treads.

(5) Swerve drive wheels have a larger contact patch surface area against the pipe. This has several benefits: (i) The swerve drive wheels don't have to be as carefully aligned to have the pressure be perfectly normal to the surface of the pipe. If the wheel is a bit offset it generally functions the same, unlike most wheels with rollers. (ii) The swerve drive wheels typically produce smoother motion as they travel along the pipe and don't suffer from the vibrations that may arise in wheels with rollers, as the pressure transitions from one roller to the next. (iii) The swerve drive wheels can distribute the same normal force (typically from the clamping mechanism) over a large surface area. This decreases the pressure which in turn decreases the potential for denting or deforming soft pipe insulation, wax tape wraps, and other materials on the exterior of the pipes.

While the present disclosure focuses on use of wheel assemblies 101, 102, etc. on the robot architecture described above, it should be recognized that wheel assemblies 101, 102, etc. may be adapted for use on other robot architectures to greater or lesser effect. Conversely, while the robot architecture described above is presented as including wheel assemblies 101, 102, etc., it should be recognized that such architecture may be adapted so as to use other types of wheels, drive components, and/or steering components to greater of lesser effect.

Further, it should be recognized that not all embodiments of wheel assemblies 101, 102, etc. must include a drive assembly 110 or any sort of drive motor whatsoever. In some embodiments, some of the wheel assemblies are powered while others have wheels 111 that freely rotate about their drive axes. Likewise, it should be recognized that not all embodiments of wheel assemblies 101, 102, etc. must include a powered steering assembly 110. In some embodiments, some of the wheel assemblies have powered steering while others freely rotate about their steering axes. In the case of the latter, reaction forces applied by the surface of the pipe 10 on the wheel 111 may cause the wheel 111 to be rotated about its steering axis into alignment with a corresponding direction of travel of the robotic apparatus 1000 along the pipe 10.

### Robotic Apparatus 2000

Embodiments of the present disclosure are further directed to a robotic apparatus 2000. Robotic apparatus 2000, in various embodiments, may be based in part on designs shown and described in U.S. patent application Ser. No. 18/198,422, entitled “Modular Pipe Traversing Apparatus” filed May 17, 2023, which is incorporated herein by reference for all purposes, and in particular robotic apparatus 100 thereof. While certain components may be the same or similar as their counterparts in the aforementioned patent application, several may differ especially in the context of the wheels used, as well as the manner in which steering and/or drive components are packaged with such wheels to provide a high-torque, low-clearance design.

Generally speaking, in various embodiments of robotic apparatus 2000, one wheel assembly of the present disclosure can replace each pair of mecanum wheels 111 described in connection with robotic apparatus 100 of the aforementioned patent application. For example, with reference to FIGS. 12A and 12B of the aforementioned patent application, wheel assembly 101 of the present disclosure could replace one of the drive platforms 110 of this and similar embodiments of the aforementioned patent application and wheel assembly 102 of the present disclosure could replace the other drive platform 110 of this and similar embodiments of the aforementioned patent application.

As configured, robotic apparatus 2000, in various embodiments, may include (i) a first wheel assembly 101 comprising a first wheel 111a, a first drive assembly 110a for driving rotation of the first wheel 111 about a first driving axis, and a first steering assembly 120 for adjusting a direction in which the first wheel 111 is steered; (ii) a second wheel assembly 102 comprising a second wheel 111b, a second drive assembly 110b for driving rotation of the second wheel 111b about a second driving axis independent of rotation of the first wheel 111a, and a second steering assembly 120b for adjusting a direction in which the second wheel 111b is steered independent of adjusting the direction in which the first wheel 111a is steered; and (iii) a clamping member 140 (analogous to various embodiments of clamping member 130 of the aforementioned patent application) coupling the first and second wheel assemblies 101, 102 and configured to (i) position the first wheel 111a on a first circumferential half of an outer surface of a pipe 10, (ii) position the second wheel 111b on a second, opposing circumferential half of the outer surface of the pipe 10, and (iii) apply a force for urging the first and second wheels 111a, 111b towards the outer surface of the pipe 10 for securing the robotic apparatus 2000 to the pipe 10. In some embodiments, wheel assembly 101 and wheel assembly 102 may be configured to be circumferentially offset from one another by about 180 degrees on the outer surface of the pipe 10.

In a related embodiment, robotic apparatus 2000 may include a third, freely-rotating wheel (about its drive axis) 111c coupled to clamping member 140. In such an embodiment, wheel assembly 101, wheel assembly 102, and freely rotating wheel 111c may be configured to be circumferentially offset from one another by about 90 degrees to about 180 degrees on the outer surface of the pipe 10.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A modular robotic apparatus, comprising:
a first module comprising:
a first wheel and a second wheel; and
a first clamping member coupling the first and second wheels and configured to (i) position the first wheel on a first circumferential one-third portion of an outer surface of a pipe, (ii) position the second wheel on a second circumferential one-third portion of the outer surface of the pipe, and (iii) apply a force for urging the first and second wheels towards the outer surface of the pipe for securing the robotic apparatus to the pipe;
a second module comprising:
a third wheel and a fourth wheel; and
a second clamping member coupling the third and fourth wheels and configured to (i) position the third wheel on the first circumferential one-third portion of the outer surface of the pipe, (ii) position the fourth wheel on a second circumferential one-third portion of the outer surface of the pipe, and (iii) apply a force for urging the third and fourth wheels towards the outer surface of the pipe for securing the robotic apparatus to the pipe; and
a third module comprising:
a fifth wheel; and
a connecting member having a first end coupled to the first module and a second end coupled to the second module so as to (i) position the fifth wheel on a third circumferential one-third portion of the outer surface of the pipe, and (ii) position the first module and second module at different axial positions along a length of the pipe,
wherein the first, second, third, fourth, and fifth wheels are each configured to permit movement of the modular robotic apparatus in axial, circumferential, and helical directions along the pipe.

2. The robotic apparatus of claim 1, wherein at least one of the first, second, third, fourth, and fifth wheels is configured to be rotated about a respective steering axis to permit movement of the modular robotic apparatus in axial, circumferential, and helical directions along the pipe.

3. The robotic apparatus of claim 2, wherein at least one of each such wheel is configured to freely rotate about its respective steering axis, such that reaction forces applied by the surface of the pipe on the wheel cause the wheel to be rotated about its steering axis into alignment with a corresponding direction of travel of the robotic apparatus along the pipe.

4. The robotic apparatus of claim 2, wherein at least one of each such wheel is coupled to a steering motor, such that actuation of the steering motor rotates the wheel about its respective steering axis to steer the robotic apparatus in axial, circumferential, and helical directions along the pipe.

5. The robotic apparatus of claim 1, wherein the first and second modules are configured to decouple from the third module.

6. The robotic apparatus of claim 5,
further comprising a fourth module comprising:
a sixth wheel and a seventh wheel; and
a third clamping member coupling the sixth and seventh wheels and configured to (i) position the sixth wheel on the first circumferential one-third portion of the outer surface of a pipe, (ii) position the seventh wheel on the second circumferential one-third portion of the outer surface of the pipe, and (iii) apply a force for urging the sixth and seventh wheels towards the outer surface of the pipe for securing the robotic apparatus to the pipe; and
further comprising a fifth module comprising:
an eighth wheel and a nineth wheel; and
a fourth clamping member coupling the eighth and ninth wheels and configured to (i) position the eighth wheel on the first circumferential one-third portion of the outer surface of a pipe, (ii) position the nineth wheel on the second circumferential one-third portion of the outer surface of the pipe, and (iii) apply a force for urging the eighth and nineth wheels towards the outer surface of the pipe for securing the robotic apparatus to the pipe,
wherein the third and fourth clamping members have at least one dimension or stiffness characteristic differing from that of the first and second clamping members, and
wherein the first and second modules are replaced by the fourth and fifth modules, respectively, so as to accommodate a second pipe having a different diameter than the pipe and/or to adjust the respective forces applied for urging the respective wheels towards the outer surface of the pipe for securing the robotic apparatus to the pipe.

7. The robotic apparatus of claim 1, wherein the first and second clamping members are configured to extend around a first portion of the circumference of the pipe, the first portion being less than the full circumference of the pipe, such that the robotic apparatus has an open side through which an obstacle extending from the pipe may pass unobstructed.

8. The robotic apparatus of claim 7, wherein the first and second wheels are coupled to first and second ends of the first clamping member, respectively, and the third and fourth wheels are coupled to first and second ends of the second clamping member, respectively.

9. The robotic apparatus of claim 7, wherein each of the first and second clamping members comprises one or more articulated joints and one or more biasing members, the biasing members being configured to generate rotational forces about the one or more articulated joints so as to urge corresponding sections of the respective clamping member towards the surface of the pipe.

10. The robotic apparatus of claim 7, wherein each of the first and second clamping members further comprises a mechanism configured to adjust a length of the respective clamping member so as to accommodate pipes of different diameters.

11. The robotic apparatus of claim 4,
wherein each steering motor is part of a corresponding steering assembly, and
wherein each steering assembly comprises the steering motor, a frame fixedly coupled to the robotic apparatus, and a steering plate fixedly coupled to the respective wheel and rotationally coupled to the frame so as to permit rotation of the steering plate about the steering axis.

12. The robotic apparatus of claim 11,
wherein each steering motor is fixedly coupled to the respective frame in an orientation configured to be parallel to the pipe, and
wherein each steering motor is coupled to the respective steering plate by a transmission.

13. The robotic apparatus of claim 12, wherein the transmission comprises:
a worm shaft coupled to the respective frame in a position between and in an orientation parallel to the respective steering motor and the respective wheel, the worm shaft having an output coupled to the respective steering plate such that rotation of the worm shaft causes the respective steering plate to rotate about the respective steering axis; and
a gear train coupling the respective steering motor output shaft to the worm shaft, such that actuation of the respective steering motor causes rotation of the respective worm shaft.

14. The robotic apparatus of claim 1 or claim 11, further comprising a drive assembly associated with each such wheel, each drive assembly comprising a drive motor and a speed reduction gearbox, the speed reduction gearbox being (i) situated within an interior of the respective wheel and (ii) coupled to an output shaft of the drive motor and the respective wheel such that actuation of the drive motor rotates the respective wheel.

15. The robotic apparatus of claim 14,
wherein each drive motor comprises a rotor and a stator, and
wherein each speed reduction gearbox comprises a strain wave gearing system, wherein a wave generator is coupled to the rotor of the respective motor, a flex spline is coupled to the respective wheel, and a circular spline is coupled to the stator of the respective motor.

16. The robotic apparatus of claim 14, wherein each drive assembly further comprises an electrical cable that is flexible in a first direction and substantially inflexible in a second direction perpendicular to the first direction, the electrical cable having:
a first end coupled to the respective frame;
a second end coupled to the respective drive motor; and
an intermediate portion situated within a channel in the steering plate, the intermediate portion being folded over in the first direction within the channel, wherein a length of the intermediate portion situated within the channel is configured to increase or decrease in response to the rotation of the steering plate,
wherein the substantial inflexibility of the electrical cable in the second direction prevents the intermediate portion situated within the channel from bending out of the channel in the second direction, such that the electrical cable does not get caught on surrounding components of the robotic apparatus and/or the pipe.

17. The robotic apparatus of claim 16, wherein the directionally flexible electrical cable is a flexible printed circuit.

18. The robotic apparatus of claim 16,
the intermediate portion comprises a first intermediate portion extending from the first end and through a guide on the drive motor; and
a second intermediate portion extending from the guide and into a channel in the steering plate, where the second intermediate portion then extends along a portion of the channel and doubles back to a hole through the steering plate and through the hole to the second end; and
wherein rotation of the steering assembly away from the first end causes at least a portion of the second intermediate portion situated within the channel to be pulled back through the guide such that the first intermediate portion lengthens to accommodate an increased distance between the first end and the guide, and
wherein rotation of the steering assembly towards the first end causes at least a portion of the first intermediate portion to be routed through the guide and into the channel such that the first intermediate portion shortens to accommodate a decreased distance between the first end the guide.

19. A robotic apparatus, comprising:
a first wheel assembly comprising a first wheel, a first drive assembly for driving rotation of the first wheel about a first driving axis, and a first steering assembly for adjusting a direction in which the first wheel is steered;
a second wheel assembly comprising a second wheel, a second drive assembly for driving rotation of the second wheel about a second driving axis independent of rotation of the first wheel, and a second steering assembly for adjusting a direction in which the second wheel is steered independent of adjusting the direction in which the first wheel is steered; and
a clamping member coupling the first and second wheel assemblies and configured to (i) position the first wheel on a first circumferential half of an outer surface of a pipe, (ii) position the second wheel on a second, opposing circumferential half of the outer surface of the pipe, and (iii) apply a force for urging the first and second wheels towards the outer surface of the pipe for securing the robotic apparatus to the pipe.

20. The robotic apparatus of claim 19, wherein the first and second drive assemblies each comprise a drive motor and a speed reduction gearbox, the speed reduction gearbox being (i) situated within an interior of the respective wheel and (ii) coupled to an output shaft of the drive motor and the respective wheel such that actuation of the drive motor rotates the respective wheel.

21. The robotic apparatus of claim 20,
wherein each drive motor comprises a rotor and a stator,
wherein each speed reduction gearbox comprises a strain wave gearing system, wherein a wave generator is coupled to the rotor of the respective motor, a flex spline is coupled to the respective wheel, and a circular spline is coupled to the stator of the respective motor.

22. The robotic apparatus of claim 19, wherein each of the first and second steering assemblies comprises:
a frame fixedly coupled to the clamping mechanism; and
a steering plate fixedly coupled to the respective drive assembly and rotationally coupled to the respective frame so as to permit rotation of the steering plate about a steering axis.

23. The robotic apparatus of claim 22, wherein steering plate is configured to rotate at least 90 degrees in at least one direction about the respective steering axis, thereby allowing the respective wheel to be steered at least 90 degrees on the surface of the pipe.

24. The robotic apparatus of claim 23, wherein the steering assemblies permit movement of the modular robotic apparatus in axial, circumferential, and helical directions along the pipe.

25. The robotic apparatus of claim 23,
wherein the steering assemblies are configured to rotate about the respective steering axis such that the wheels are oriented to rotate about their drive axes in a circumferential direction along the surface of the pipe, and
wherein the drive assemblies are individually controlled to drive rotation of the respective wheels about their respective driving axes, such that when the wheels make contact with the pipe during the installation, the drive assemblies pull the robotic apparatus in a radial direction onto the pipe, thereby aiding an operator in installing the robotic apparatus onto the pipe.

26. The robotic apparatus of claim 22, wherein each of the first and second steering assemblies further comprises a steering motor configured to rotate the respective steering plate about the respective steering axis.

27. The robotic apparatus of claim 26,
wherein each steering motor is fixedly coupled to the respective frame in an orientation configured to be parallel to the pipe, and
wherein each steering motor is coupled to the respective steering plate by a transmission.

28. The robotic apparatus of claim 27, wherein the transmission comprises:
a worm shaft coupled to the respective frame in a position between and in an orientation parallel to the respective steering motor and the respective wheel, the worm shaft being coupled to the respective steering plate such that rotation of the worm shaft causes the respective steering plate to rotate about the respective steering axis; and
a gear train coupling the respective steering motor to the worm shaft, such that actuation of the respective steering motor causes rotation of the respective worm shaft.

29. The robotic apparatus of claim 22,
wherein each drive assembly further comprises an electrical cable that is flexible in a first direction and substantially inflexible in a second direction perpendicular to the first direction, the electrical cable having:
a first end coupled to the respective frame;
a second end coupled to the respective drive motor; and
an intermediate portion situated within a channel in the steering plate, the intermediate portion being folded over in the first direction within the channel, wherein a length of the intermediate portion situated within the channel is configured to increase or decrease in response to the rotation of the steering plate,
wherein the substantial inflexibility of the electrical cable in the second direction prevents the intermediate portion situated within the channel from bending out of the channel in the second direction, such that the electrical cable does not get caught on surrounding components of the robotic apparatus and/or the pipe.

30. The robotic apparatus of claim 29, wherein the directionally flexible electrical cable is a flexible printed circuit.

31. The robotic apparatus of claim 29,
the intermediate portion comprises a first intermediate portion extending from the first end and through a guide on the drive motor; and
a second intermediate portion extending from the guide and into a channel in the steering plate, where the second intermediate portion then extends along a portion of the channel and doubles back to a hole through the steering plate and through the hole to the second end; and
wherein rotation of the steering assembly away from the first end causes at least a portion of the second intermediate portion situated within the channel to be pulled back through the guide such that the first intermediate portion lengthens to accommodate an increased distance between the first end and the guide, and
wherein rotation of the steering assembly towards the first end causes at least a portion of the first intermediate portion to be routed through the guide and into the channel such that the first intermediate portion shortens to accommodate a decreased distance between the first end the guide.

32. The robotic apparatus of claim 19, wherein the first and second wheel assemblies are configured to be circumferentially offset from one another by about 180 degrees on the outer surface of the pipe.

33. The robotic apparatus of claim 19,
further comprising a third freely-rotating wheel coupled to the clamping member, and
wherein the first wheel assembly, the second wheel assembly, and the third freely-rotating wheel are configured to be circumferentially offset from one another by about 90 degrees to about 180 degrees on the outer surface of the pipe.

34. The robotic apparatus of claim 19,
further comprising a third wheel assembly comprising a third wheel, a third drive assembly for driving rotation of the third wheel, and a third steering assembly for adjusting a direction in which the third wheel is steered, and
wherein the first, second, and third wheel assemblies are configured to be circumferentially offset from one another by about 90 degrees to about 180 degrees on the outer surface of the pipe.

35. The robotic apparatus of claim 19, wherein the clamping member is configured to extend around a first portion of the circumference of the pipe, the first portion being less than the full circumference of the pipe, such that the robotic apparatus has an open side through which an obstacle extending from the pipe may pass unobstructed.

36. The robotic apparatus of claim 35, wherein the first wheel assembly is coupled to a first end of the clamping member and the second wheel assembly is coupled to a second end of the clamping member.

37. The robotic apparatus of claim 19, wherein the clamping member comprises one or more articulated joints and one or more biasing members, the biasing members being configured to generate rotational forces about the one or more articulated joints so as to urge corresponding sections of the clamping member towards the surface of the pipe.

38. The robotic apparatus of claim 19,
wherein the clamping member is elastically deformable between a neutral, unloaded state and an expanded, loaded state, and
wherein the clamping member is dimensioned relative to a diameter of the pipe such that the clamping member is in the expanded, loaded state when the first and second wheels are positioned on the outer surface of the pipe, such that the loads urge portions of the clamping member towards the surface of the pipe.

39. The robotic apparatus of claim 38, wherein the clamping member further comprises a mechanism configured to adjust the loads for urging portions of the clamping member towards the surface of the pipe.

40. The robotic apparatus of claim 19, wherein the clamping member further comprises a mechanism configured to adjust a length of the clamping member so as to accommodate pipes of different diameters.
